(19) United States
(12) Patent Application Publication
(10) Pub. No.: US 2012/0031052 A1
(43) Pub. Date: Feb. 9, 2012

(54) ROLL OF FOLDED WRAPPING MATERIAL

(76) Inventors: Donald E. Weder, Highland, IL (US); Andrew Weder, Highland, IL (US)

(21) Appl. No.: 13/271,788

(22) Filed: Oct. 12, 2011

Related U.S. Application Data
(63) Continuation of application No. 12/220,387, filed on Jul. 23, 2008.
Application No. 12/220,387 is a continuation of application No. 11/147,103, filed on Jun. 7, 2005, now abandoned.

(51) Int. Cl. B65B 11/00; B32B 3/04

(52) U.S. Cl. 53/461; 428/124

(57) ABSTRACT

A roll of folded wrapping material such as a packaging or gift material and methods of use thereof are disclosed. The roll is constructed of a folded length of sheet material that may be wrapped about an inner core or tube. The length of the core used to form the roll of folded wrapping material can therefore be reduced to about half of the length of a core of a standard roll of wrapping material, thereby reducing the amount of shelf space needed to store the roll.

### CROSS-REFERENCE TO RELATED APPLICATIONS

This application is a continuation of U.S. Ser. No. 12/220,387, filed Jul. 24, 2008, now abandoned; which is a continuation of U.S. Ser. No. 11/147,103, filed Jun. 7, 2005, now abandoned. The entire contents of the above-referenced patent applications are hereby expressly incorporated herein by reference.

### STATEMENT REGARDING FEDERALLY SPONSORED RESEARCH OR DEVELOPMENT

Not applicable.

### BACKGROUND OF THE INVENTION

The present inventive concept(s) relates in general to packages of sheet material formed into rolls, and methods of use thereof.

In the field of gift wrap sheet material, a great variety of patterns, colors, finishes, and sizes of packages must be produced. In the marketing of such sheet material, it has been found that consumers often prefer relatively small amounts of any one type of gift wrap sheet material. Accordingly, it is often not practical for the manufacturer to package large quantities of one type of gift wrap sheet material for retail sale.

However, for the manufacturer, and ultimately for the consumer, the practice of providing a separate stiff core for each roll of a relatively short length of sheet material is expensive and not in the spirit of conservation. Each roll of gift wrap material generally has a low cost, but requires a large volume of shelf space for display and storage for a relatively minor amount of sheet material. This results in a relatively high “shelf space to cost” ratio, which greatly reduces the profit margin on each item. In fact, the shelf space for each roll of gift wrap is primarily consumed by the core, rather than by the relatively small amount of gift wrap material which is wrapped about the core.

It would therefore be desirable for the consumer, manufacturer and retail seller to have a roll of gift wrap material which took up less space than currently on the market items and which also reduced the eventual wastage of the core.

### BRIEF DESCRIPTION OF THE DRAWINGS

FIG. 1 is a perspective view of one embodiment of a roll of folded wrapping material of the presently disclosed and claimed inventive concept(s).

FIG. 2 is a transverse cross-sectional view of the roll of folded wrapping material of FIG. 1.

FIG. 3 is a longitudinal cross-sectional view of the roll of folded wrapping material of FIG. 1.

FIG. 4 is a longitudinal cross-sectional view of another embodiment of the roll of folded wrapping material of the presently disclosed and claimed inventive concept(s).

FIG. 5 is a perspective view of an apparatus for making the roll of folded wrapping material of the presently disclosed and claimed inventive concept(s).

### DETAILED DESCRIPTION OF THE INVENTION

Currently, rolls of wrapping material are sold as a long unfolded web of material which is taken up on a cylindrical tube or core. For example, if the web of material has a width of 30 inches, the length of material when wrapped about the core also has a width of 30 inches. Conversely, in the presently disclosed and claimed inventive concept(s), as described in more detail below, the web of material is in one embodiment doubled over (folded in half lengthwise) before being taken up on the core, thereby providing a length of folded material on the roll. For example, if the original web of material has a width of 30 inches, the length of folded material on the roll will have a width of about 15 inches. The length of the core upon which the folded material is rolled can therefore be reduced to about half of the length of a core of a standard roll of wrapping material thereby reducing the amount of shelf space needed to store the roll and greatly benefitting the consumer, manufacturer, retailer, and the environment by reducing land fill needs.

The presently disclosed and claimed inventive concept(s) therefore is a roll of folded wrapping material and a method of use thereof for wrapping gift items or other items. Where used herein, the term “gift item” may include potted plants of floral groupings such as bouquets or cut flowers.

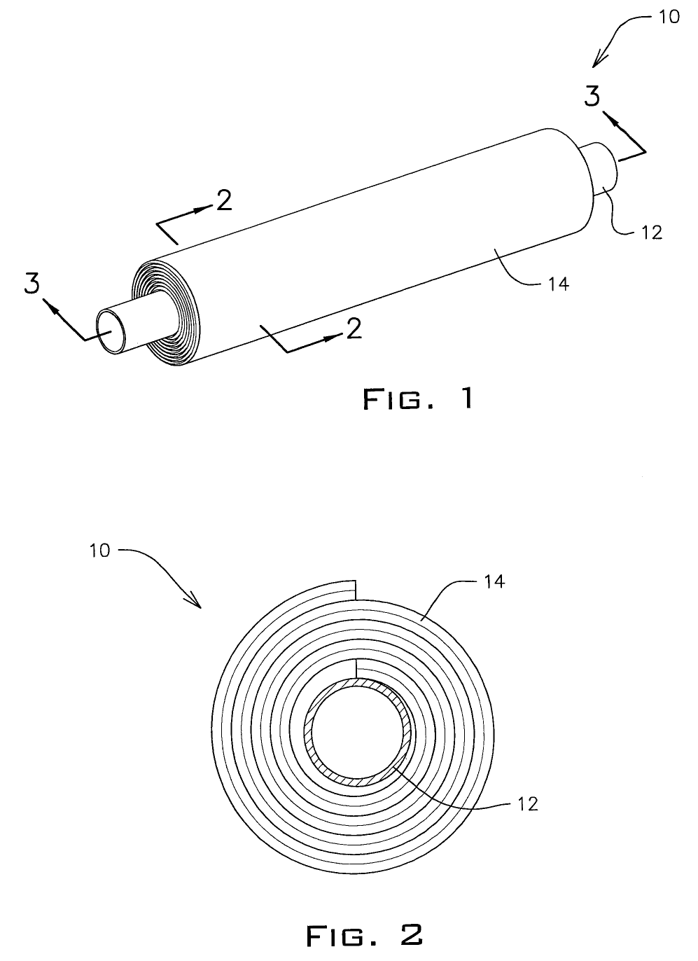

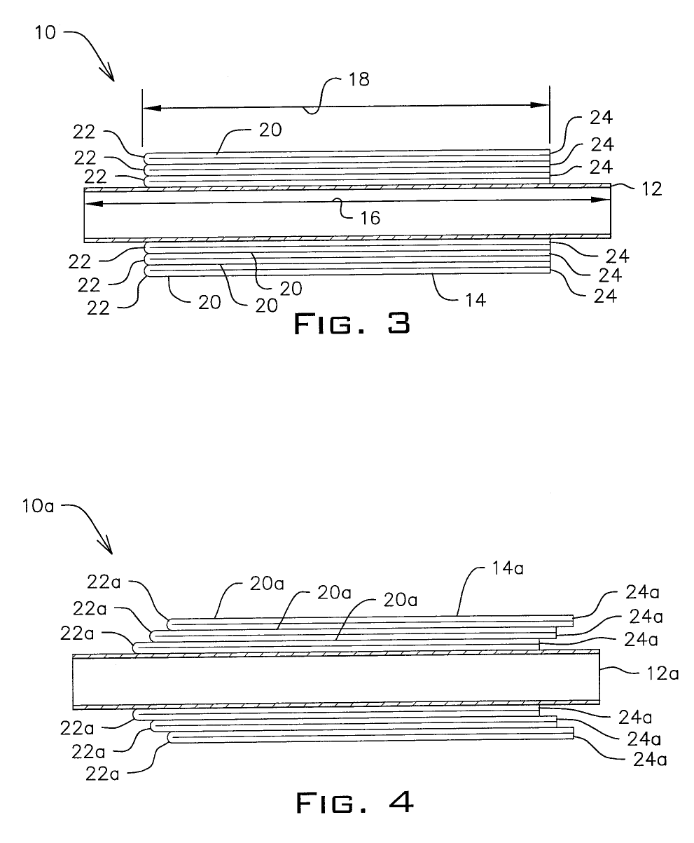

Referring now to the drawings, shown in FIGS. 1-4 and referred to therein by the general reference numeral 10 is a roll of folded wrapping material. The roll of folded wrapping material 10 is constructed of cylindrical inner core 12 (a tube) and a length of a folded sheet material 14 which is wrapped concentrically about the inner core 12. The folded sheet material 14 preferably is non-tubular (but may be a folded tubular material). The inner core 12 has a length 16 and the folded sheet material 14 has a width 18 which preferably is less than or equal to the length 16 of the inner core 12. The roll of folded wrapping material 10 preferably comprises a plurality of folded layers 20, each folded layer 20 having a fold line 22 which comprises a closed lengthwise side of the folded layer 20. Parallel to and opposite of the fold line 22 of the folded layer 20 is an open lengthwise side 24. The folded layer 20 therefore does not comprise a closed tube (although the wrapping material used to form the folded sheet material 14 may be constructed of a tubular material). Fold lines 22 of adjacent folded layers 20 may be disposed directly upon one another, as shown in FIG. 3. Alternatively, the fold lines of adjacent folded layers may be slightly offset relative to one another. For example, shown in FIG. 4 is a roll of folded wrapping material 10a having an inner core 12a which has a length of folded sheet material 14a concentrically wrapped thereabout to form a plurality of folded layers 20a, each having a fold line 22a. Each fold line 22a is slightly offset relative to the position of the fold line 22a of the folded layer 20a adjacent thereto in this embodiment of the presently disclosed and claimed inventive concept(s).

The inner core 12 or 12a may be constructed of any material typically used by persons of ordinary skill in the art to construct such cores, for example, cardboard or plastic. The material used to construct the length of folded sheet material 14 or 14a may be any flexible material used by a person of ordinary skill in the art of gift wrapping or wrapping of other packages or items. For example, it may be plastic, paper, synthetic or non-synthetic polymeric film, or non-polymeric film, foil, a rubber or rubberized material, a fabric comprised of natural or synthetic materials, net, cellophane, shrinkable materials (e.g., heat shrinkable), or combinations or laminations thereof.

The roll of folded wrapping material 10 or 10a is preferably covered with a transparent film or bag (not shown) for sale and labeled and may be packaged together as multiple rolls in a manner well known to those of ordinary skill in the art.

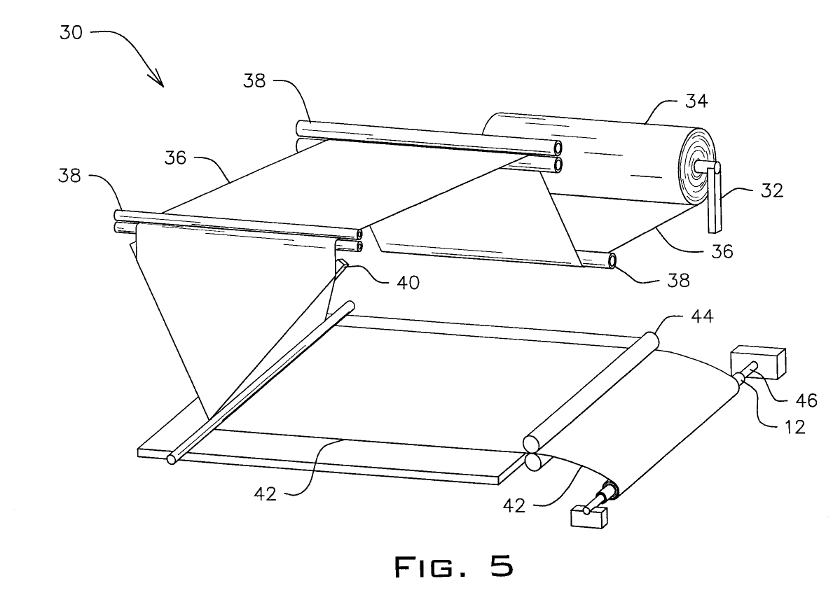

The roll of folded wrapping material 10 or 10a may be produced by any suitable manner which enables a web of material to be folded lengthwise. For example, one such apparatus for folding and rolling is shown in FIG. 5. An apparatus 30 comprises a mechanism 32 for supporting a roll of material 34. A single web of material 36 from the roll of material 34 is fed by a drive mechanism (not shown) through rollers 38 to a folding assembly 40 such as an A-frame which causes the web of material 36 to be doubled over to form a folded web 42. The folded web 42 is then advanced by drive rollers 44 or other advancing mechanism where it is taken up onto the inner core 12 or 12a which is removably positioned upon a mandrel 46. After an amount of the folded web 42 is taken up on the inner core 12 or 12a, the folded web 42 is cut and the resulting roll of folded wrapping material 10 or 10a as shown in FIGS. 1-4 is removed from the mandrel 46 for further packaging. Although the web of material 36 is shown in FIG. 5 as being folded in only one position lengthwise, in an alternative embodiment the web of material 36 may be folded over in two lengthwise positions to form a folded web which is folded in “thirds” rather than merely “doubled-over”. In another embodiment, the folded web 42 may be folded again to form a folded web which is folded over in “fourths” before being taken up on the inner core 12 or 12a.

In use, a portion (not shown) of the folded sheet material 14 or 14a, or other folded sheet material as described herein, is removed from the roll of folded wrapping material 10 or 10a, respectively. The portion of the folded sheet material 14 or 14a comprising a sheet of material is then unfolded and disposed about the gift item or other item, or in another method of use, is left in a folded condition and is disposed about the gift item or other item.

While the presently disclosed and claimed inventive concept(s) is described above in connection with certain embodiments so that aspects thereof may be more fully understood and appreciated, it is not intended that the presently disclosed and claimed inventive concept(s) be limited to these particular embodiments. On the contrary, it is intended that all alternatives, modifications and equivalents are included within the scope of the inventive concept(s) as defined by the appended claims. Thus the examples described above, which include preferred embodiments, will serve to illustrate the practice of the presently disclosed and claimed inventive concept(s), it being understood that the particulars shown are by way of example and for purposes of illustrative discussion of preferred embodiments of the presently disclosed and claimed inventive concept(s) only and are presented in the cause of providing what is believed to be the most useful and readily understood description of procedures as well as of the principles and conceptual aspects of the presently disclosed and claimed inventive concept(s).

Changes may be made in the construction and the operation of the various components, elements and assemblies described herein or in the steps or the sequence of steps of the methods described herein without departing from the spirit and scope of the inventive concept(s) as defined in the following claims.

What is claimed is:

1. A roll of folded wrapping material, comprising a folded material rolled concentrically, wherein the folded material is formed of a web of wrapping material having a length, the folded material having at least one lengthwise fold which extends the entire length thereof such that the web of wrapping material is folded over upon itself along the entire length thereof, such that the folded material has an open lengthwise side and a closed lengthwise side.

2. The roll of folded wrapping material of claim 1, further comprising a cylindrical core upon which the folded material is rolled concentrically.

3. The roll of folded wrapping material of claim 2, wherein the cylindrical core has a length of 18 inches or less.

4. The roll of folded wrapping material of claim 1, wherein the folded material is a decorative gift wrap.

5. The roll of folded wrapping material of claim 1, wherein the folded material is constructed of at least one material selected from the group consisting of plastic, paper, synthetic polymeric film, non-synthetic polymeric film, non-polymeric film, foil, a rubber material, a rubberized material, a fabric comprised of natural materials, a fabric comprised of synthetic materials, net, cellophane, shrinkable materials, and combinations and laminations thereof.

6. A method of wrapping an item, comprising the steps of:
providing a roll of folded wrapping material comprising a folded material rolled concentrically, wherein the folded material is formed of a web of wrapping material having a length, the folded material having at least one lengthwise fold which extends the entire length thereof such that the web of wrapping material is folded over upon itself along the entire length thereof, such that the folded material has an open lengthwise side and a closed lengthwise side;
obtaining a sheet of material from the roll of folded wrapping material;
unfolding at least a portion of the sheet of material; and
disposing the unfolded sheet of material about an item and wrapping the unfolded sheet of material substantially about the item such that at least a portion of the item is substantially encompassed by and covered by the sheet of material, thereby providing a wrapper for the item.

7. The method of claim 6 wherein, in the step of disposing the unfolded sheet of material about an item, the item is a gift item.

8. The method of claim 6 wherein, in the step of providing a roll of folded wrapping material, the folded material of the roll of folded wrapping material is constructed of at least one material selected from the group consisting of plastic, paper, synthetic polymeric film, non-synthetic polymeric film, non-polymeric film, foil, a rubber material, a rubberized material, a fabric comprised of natural materials, a fabric comprised of synthetic materials, net, cellophane, shrinkable materials, and combinations and laminations thereof.

9. The method of claim 6 wherein, in the step of providing a roll of folded wrapping material, the roll of folded wrapping material further comprises a cylindrical core upon which the folded material is rolled concentrically.

10. The method of claim 9, wherein the cylindrical core of the roll of folded wrapping material has a length of 18 inches or less.

11. The method of claim 6 wherein, in the steps of obtaining a sheet of material and unfolding at least a portion of the sheet of material, the sheet of material is substantially flat when unfolded.

12. The method of claim 6 wherein, in the step of unfolding at least a portion of the sheet of material, the sheet of material is provided with a left side edge and a right side edge, and the left and right side edges are not in contact with one another when the sheet is unfolded.
